(19) United States
(12) Patent Application Publication
(10) Pub. No.: US 2024/0369224 A1
(43) Pub. Date: Nov. 7, 2024

(54) SYSTEMS AND METHODS FOR REDUCING EMISSIONS IN GAS TURBINE ENGINES

(71) Applicant: GE Infrastructure Technology LLC, Greenville, SC (US)

(72) Inventors: Mihir K. Lal, Greer, SC (US); Mark W. Pinson, Greer, SC (US); Kamil Kaczorowski, Warsaw (PL); Pawel Oleszczak, Pruszkow (PL)

(21) Appl. No.: 18/651,223

(22) Filed: Apr. 30, 2024

Related U.S. Application Data
(60) Provisional application No. 63/499,364, filed on May 1, 2023.

(30) Foreign Application Priority Data
Mar. 13, 2024 (PL) P.447993

(51) Int. Cl. F23N 5/00; F02C 7/057; F23L 7/00

(52) U.S. Cl. CPC F23N 5/006; F02C 7/057; F23L 7/00; F05D 2270/08; F23N 2225/21; F23N 2241/20

(57) ABSTRACT

A power generation system includes a gas turbine engine having a compressor section, a combustor section, and a turbine section. The power generation system includes a diluent supply system for supplying a diluent to the compressor section. The supplied diluent and ambient air are compressed together by the compressor section before being transferred to the combustor section. A method for facilitating improved emissions performance of the gas turbine engine using such a system is also provided.

### CROSS-REFERENCE TO RELATED APPLICATIONS

This application claims the benefit of priority to U.S. Provisional Patent Application No. 63/499,364, filed May 1, 2023, entitled “SYSTEMS AND METHODS FOR REDUCING EMISSIONS IN GAS TURBINE ENGINES,” and the Poland Application No. P.447993, filed Mar. 13, 2024, entitled “SYSTEMS AND METHODS FOR REDUCING EMISSIONS IN GAS TURBINE ENGINES,” the entire contents and disclosures of which are hereby incorporated by reference herein in their entirety.

### BACKGROUND

The field of the disclosure relates generally to gas turbine engines and, more particularly, to systems and methods for supplying a diluent to a compressor section of a gas turbine engine to reduce emissions.

Gas turbine engines are widely used in industrial and power generation operations. A conventional gas turbine engine includes a compressor section, a combustor section downstream from the compressor section, and a turbine section downstream from the combustor section. A working fluid, such as ambient air, flows into the compressor section where it is compressed before passing into the combustor section. The compressed working fluid is mixed with a fuel and burned within the combustor section to generate combustion gases which expand through the turbine section to rotate a shaft, producing electricity.

In at least some known gas turbine engines, the compressed working fluid contains an excess quantity of oxygen compared to an amount of oxygen required to support combustion. As a result, temperatures within the combustor section may be elevated and various undesirable emissions may be produced, including but not limited to, nitrous oxides (hereinafter NOx). Accordingly, reducing the available oxygen entering the combustor section regulates working temperatures and reduces the production of NOx.

Various methods are known in the art for regulating combustion temperatures and reducing the production of NOx within the combustor section. One known method includes supplying a diluent to the working fluid to decrease the oxygen content prior to combustion. The diluted working fluid still includes sufficient oxygen to support combustion. Various diluents, for example, steam, nitrogen gas (N₂), and/or carbon dioxide (CO₂), may be used. The diluent may be pressurized by an auxiliary compressor before the pressurized diluent is introduced into the combustor section. Since the auxiliary compressor is separate from the compressor section of the gas turbine engine, the auxiliary compressor requires one or more energy sources, reducing the overall power efficiency of the gas turbine engine.

Accordingly, a need exists for reducing NOx emissions from gas turbine engines with improved power efficiency. It would be desirable to further reduce flame temperatures and/or emissions such as NOx within a gas turbine engine, without requiring substantial reconfiguration or redesign of existing turbine engine hardware.

### SUMMARY

In one aspect, a method of supplying a diluent to a gas turbine engine is provided. The method includes injecting a diluent into a compressor section of the gas turbine engine and channeling ambient air into the compressor section. The method further includes compressing the diluent and ambient air together within the compressor section to facilitate improved emissions performance of the gas turbine engine.

In another aspect, a power generation system includes a gas turbine engine. The gas turbine engine includes a compressor section including an inlet, a combustor section downstream from the compressor section, and a turbine section downstream from the combustor section. The turbine section discharges an exhaust gas therefrom during operation. The system further includes a diluent supply system for supplying a diluent to the compressor section, wherein the diluent and ambient air are compressed together by the compressor section before being routed downstream into the combustor section.

In another aspect, a gas turbine engine is provided. The gas turbine engine includes a compressor section including an inlet, a combustor section downstream from the compressor section, and a turbine section downstream from the combustor section, the turbine section discharging an exhaust gas therefrom during operation. The diluent control system includes a diluent supply system for supplying a diluent into the compressor section, wherein the diluent and ambient air are compressed together by the compressor section before being routed downstream into the combustor section. The diluent supply system includes at least one flow control device for controlling a flow parameter of the diluent supplied to the compressor section.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary power generation system including a diluent supply system including a known auxiliary diluent compressor used to compress diluent before suppling diluent into a combustor section of a gas turbine engine;

FIG. 2 is a schematic illustration of an alternative power generation system with improved emission performance and with a diluent supply system for supplying diluent into a compressor section of a gas turbine engine;

FIG. 3 is a schematic illustration of another alternative power generation system with improved emission performance and with a diluent supply system for supplying diluent into a compressor section of a gas turbine engine;

FIG. 4 is a schematic illustration of another alternative power generation system with improved emission performance and with a diluent supply system for supplying diluent into a compressor section and a combustor section of a gas turbine engine;

FIG. 5 is a block diagram of an exemplary diluent control system that may be used with the diluent supply system shown in FIGS. 2-4; and

FIG. 6 is a flow chart of an exemplary method of improving the emission performance of a gas turbine engine with a diluent supply system as shown in FIGS. 2-5.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings. The singular forms “a,” “an,” and “the” include plural references unless the context clearly dictates otherwise. “Optional” or “optionally” means that the subsequently described event or circumstance may or may not occur, and that the description includes instances where the event occurs and instances where it does not. Furthermore, references to “one embodiment” are not intended to be interpreted as excluding the existence of additional embodiments that also incorporate the recited features. Moreover, unless explicitly stated to the contrary, embodiments “including” or “having” an element or a plurality of elements having a particular property may include additional such elements not having that property.

As used herein, the term “real-time” refers to either the time of occurrence of the associated events, the time of measurement and collection of predetermined data, the time to process the data, or the time of a system response to the events and the environment. In the embodiments described herein, these activities and events occur substantially instantaneously.

As used herein, the terms “processor” and “computer” and related terms, e.g., “processing device,” “computing device,” and “controller” are not limited to just those integrated circuits referred to in the art as a computer, but instead refer broadly to a microcontroller, a microcomputer, a programmable logic controller (PLC), an application specific integrated circuit, and/or other programmable circuits, and such terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to only being, computer peripherals associated with an operator interface such as a mouse and a keyboard. Alternatively, other computer peripherals may also be used such as, but not limited to, a scanner or a touchscreen. Furthermore, in the embodiments described herein, additional output channels may include, but are not limited to only being, an operator interface monitor.

Embodiments described herein relate to power generation systems that utilize diluents to facilitate decreasing the production of emissions, while improving the energy efficiency of the power generation system. In particular, elevated temperatures within a combustor section may produce various undesirable emissions, for example, nitrous oxides (NOx). Accordingly, decreasing working temperatures by reducing available oxygen entering the combustion section generally reduces the production of NOₓ. Embodiments described herein mitigate climate change by reducing emissions. Emissions are reduced by supplying a diluent to the working fluid to reduce the available oxygen content of the working fluid, thereby controlling the combustion temperatures.

In embodiments described herein, diluent is supplied directly to a compressor section of a gas turbine engine, where the diluent, along with ambient air, is compressed by the compressor section before the compressed mixture is directed into the combustor section. Diluent is introduced directly into the compressor section without compressing the diluent using a separate, e.g., an auxiliary, compressor. Accordingly, in at least some of the embodiments described herein, additional power for driving an auxiliary compressor to compress the diluent, separate from the compressor section of the gas turbine engine, is not required. In other embodiments, at least a portion of the diluent is supplied directly to the compressor section and another portion is directed to an auxiliary compressor before being introduced into the combustor section. The relative portions of diluent supplied to the compressor section and to the combustor section may be adjusted based on the operating needs and emission goals of the power generation system.

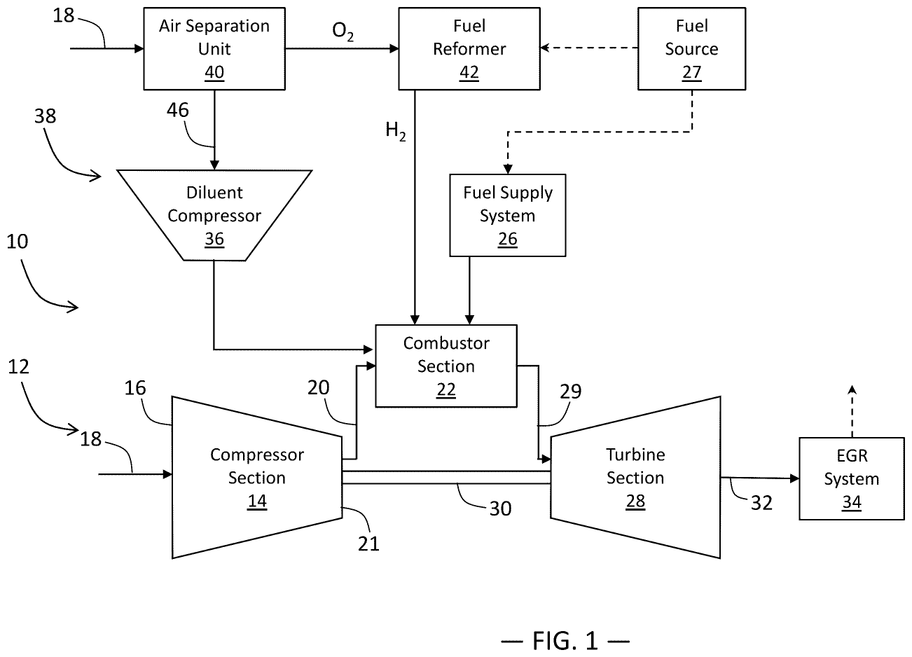

Referring now to the drawings, FIG. 1 illustrates a schematic power generation system 10. As shown, power generation system 10 generally includes a gas turbine engine 12. Gas turbine engine 12 generally includes a compressor section 14 having an inlet 16 for receiving ambient air 18 as a working fluid. Ambient air 18 is compressed as it flows through compressor section 14. Compressed working fluid 20 exits compressor section 14 through an outlet 21 of compressor section 14 and is directed into a combustor section 22 downstream from compressor section 14. Although only a single combustor section 22 is illustrated, it should be appreciated by one of ordinary skill in the art that gas turbine engine 12 may include a plurality of combustor sections (e.g., combustor cans) generally arranged in an annular pattern about an axial centerline of gas turbine engine 12. Combustor section 22 may be a staged combustor that includes at least a first stage and a second stage, which are separated by an intermediate turbine stage (not depicted). Alternatively, combustor section 22 may be an axially staged combustor in which fuel is introduced into two or more axially separated combustion zones within the same combustion section 22.

A fuel supply system 26 in fluid communication with combustor section 22 supplies a fuel from a fuel source 27 to combustor section 22. Compressed working fluid 20 is mixed with the fuel to form a combustible mixture within combustor section 22. The combustible mixture is ignited within a combustion zone of combustor section 22, thereby generating combustion gases 29 having a high temperature and velocity. Combustion gases 29 exit combustor section 22 and rapidly expand through a turbine section 28 downstream from combustor section 22. The combustion gases 29 impart kinetic and thermal energy to one or more rows of rotatable blades (not shown) coupled to a shaft 30, thereby causing shaft 30 to rotate and produce mechanical work. Shaft 30 may be coupled to a load and/or to a generator (not shown) to produce electricity or to extract power/torque. The combustion gases flow out of turbine section 28 as exhaust gases 32. In some embodiments, exhaust gases 32 may undergo emission control treatment (e.g., selective catalytic reduction) to remove unwanted combustion byproducts (e.g., NOₓ) from exhaust gases 32.

In the exemplary embodiment, power generation system 10 includes an exhaust gas reclaimer 34 (herein referred to as the “EGR system 34”). Exhaust gases 32 may be used for other auxiliary purposes, as described in more detail below.

Power generation system 10 may also include an air separation unit 40 that receives ambient air 18 and separates ambient air 18 into oxygen gas (e.g., O₂) and one or more byproducts. Byproducts of air separation unit 40 may include a diluent 46, such as nitrogen gas (e.g., N₂), that may be stored and/or used for other applications. In power generation system 10, the byproducts are used in diluent supply system 38. In FIG. 1, diluent supply system 38 may include a diluent compressor 36. Diluent compressor 36 compresses diluent 46 prior to compressed diluent 46 being channeled into combustor section 22. In such an embodiment, diluent compressor 36 is an auxiliary compressor that is separate and distinct from compressor section 14 and that is driven by a power source (not shown). For example, in such embodiments, diluent compressor 36 is driven by power generated by gas turbine engine 12, thus representing a parasitic energy loss for the gas turbine engine 12.

In some embodiments, power generation system 10 includes a fuel reformer 42, e.g., a methane or natural gas reformer, that facilitates converting methane and oxygen into carbon dioxide and hydrogen (e.g., H₂). In operation, reformer 42 receives a flow of natural gas 44 (e.g., from fuel source 27) and a flow of oxygen produced by air separation unit 40. The resulting hydrogen stream is directed into combustor section 22 wherein the hydrogen may be used as a fuel source, or alternatively, hydrogen may supplement a separate fuel source. The supply of hydrogen into combustor section 22 may be incorporated with fuel supply system 26, and/or the supply of hydrogen may supplement fuel supply system 26. Alternatively, power generation system 10 may include any suitable fuel supply system that enables power generation system 10 to function as described herein.

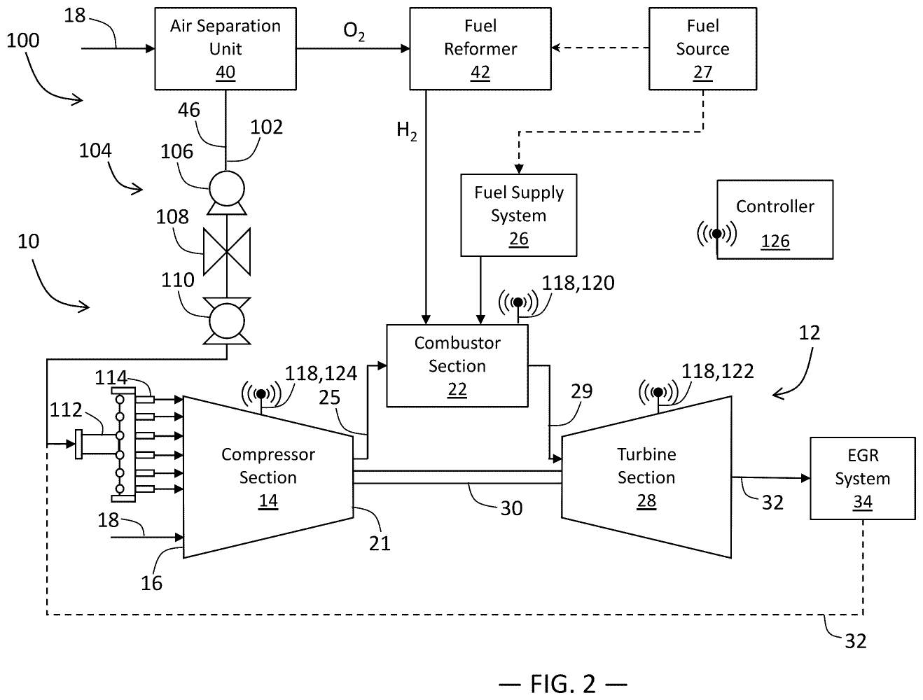

In the exemplary embodiments described herein with references to FIGS. 2-6, diluent 46 may include, but is not limited to only including, an oxidizer, water, steam, and/or an inert gas such as nitrogen (e.g., N₂) and/or carbon dioxide (CO₂). In embodiments described herein, diluent 46 may include any substance which supports a combustion process and/or that facilitates reducing undesirable emissions such as nitrogen oxides (NOₓ).

Referring now to FIG. 2, power generation system 10 includes an exemplary diluent supply system 100 that is fluidly coupled with compressor section 14 such that diluent supply system 100 may supply diluent 46 to compressor section 14. Moreover, in the exemplary embodiment, diluent supply system 100 includes one or more conduits, pipes, ducts, and/or tubes, generally referred to herein as conduits 102, that channel diluent 46 to compressor section 14. In some embodiments, diluent 46 is routed through conduits 102 towards compressor section 14 using gravitational forces. In some embodiments, air separation unit 40 discharges nitrogen at a pressure that is greater than a pressure of ambient air 18 and/or greater than a pressure of ambient air 18 at inlet 16 of compressor section 14. This increased pressure of nitrogen may motivate the nitrogen through conduits 102 towards compressor section 14.

Alternatively, and/or additionally, diluent supply system 100 includes one or more flow control devices 104 that control the movement of diluent 46 to compressor section 14. For example, flow control devices 104 may control at least one of a velocity of diluent 46, a mass flow rate of diluent 46, and/or a volume of diluent 46 supplied to compressor section 14. Flow control devices 104 may include one or more pumps 106 and/or valves 108. In addition, diluent supply system 100 may include a flow measurement device 110, e.g., a flow meter, used to measure a flow parameter of diluent 46, such as a velocity and/or a mass flow rate of diluent 46 moving through conduits 102.

In some embodiments, diluent 46 may include exhaust gases 32 (e.g., combined with nitrogen from air separation unit 40), or diluent 46 may be entirely composed of exhaust gases 32 or a constituent species of the exhaust gases (e.g., CO₂). For example, in some embodiments, diluent supply system 100 circulates exhaust gases 32 exiting turbine section 28 towards inlet 16 of compressor section 14 (e.g., via manifold 112). Alternatively, and/or additionally, diluent supply system 100 may introduce exhaust gases 32 into compressor section 14, without compressing exhaust gases 32 using an auxiliary compressor, such as diluent compressor 36 (FIG. 1).

In the exemplary embodiment, diluent supply system 100 includes a manifold 112 including one or more outlets 114 that distribute diluent 46 at inlet 16 of compressor section 14. In some embodiments, diluent supply system 100 may supply diluent 46 to compressor section 14 in proximity to inlet 16, such as less than about 1 meter, less than about 0.5 meters, or less than about 0.25 meters from inlet 16. In some embodiments, diluent supply system 100 supplies diluent 46 at any suitable location that is upstream from compressor section 14. Diluent 46 may be introduced into compressor section 14 such that diluent 46 enters inlet 16 of compressor section 14 with a flow direction that is generally the same direction, e.g., parallel to, a flow direction of ambient air 18 entering inlet 16. Accordingly, diluent 46 is introduced into compressor section 14 without creating turbulence with ambient air 18 entering compressor section 14.

In some embodiments, power generation system 10 includes an air filtration system, not shown, arranged in proximity to inlet 16 of compressor section 14. The air filtration system may filter air to remove impurities and/or debris within ambient air 18 before the filtered air is introduced into inlet 16. In such embodiments, diluent supply system 100 may introduce diluent 46 into the air filtration system. For example, manifold 112 may distribute diluent 46 into an inlet of the air filtration system.

Alternatively, and/or additionally, diluent supply system 100 may introduce diluent 46 into any intermediate location of compressor section 14 between inlet 16 and outlet 21, such that compressor section 14 may compress diluent 46 prior to it being directed to combustor section 22. For example, in some embodiments, diluent supply system 100 may introduce diluent 46 to compressor section 14 at any location that is upstream of outlet 21 of compressor section 14.

In some embodiments, diluent supply system 100 may include one or more nozzles (not shown) used to inject diluent 46 into compressor section 14, near or at inlet 16 of compressor section 14, or at any intermediate location of compressor section 14 that is upstream from outlet 21. The one or more nozzles may include the outlets 114 of the manifold 112. In alternative embodiments, diluent 46 may be combined with ambient air 18 before the combined mixture is directed into inlet 16. The combined and compressed stream 25 of ambient air 18 and diluent 46 (which may include or be entirely composed of exhaust gases 32) is then provided to the combustor section 22.

Diluent supply system 100 may include one or more sensors 118 for detecting conditions associated with the emission performance of power generation system 10. Sensors 118 may include a temperature sensor 120 that measures an operating temperature within combustor section 22, such as a combustor inlet temperature, a burner temperature, and/or a combustor metal temperature. In alternative embodiments, sensors 118 may be coupled to turbine section 28 to detect operating parameters of turbine section 28, such as a local turbine operating temperature, a turbine inlet temperature, and/or a turbine outlet temperature. In still other embodiments, sensor 118 may be a pressure sensor that measures an operating pressure within combustor section 22 and/or turbine section 28. Sensors 118 may be any other sensor used to obtain any other measurement of an operating parameter of gas turbine engine 12 that enables diluent supply system 100 to function as described herein. For example, sensors 118 may include an emissions sensor 122 that detects a level of one or more pollutants (e.g., CO and/or NOₓ) in exhaust gases 32, and/or an oxygen sensor 124 that detects oxygen levels, e.g., available oxygen to support combustion in working fluid 18. For example, oxygen sensor 124 may be located at compressor inlet 16, compressor outlet 21, and/or at combustor section 22. Oxygen sensor 124 may be oriented in any location that enables diluent supply system 100 to function as described herein.

Sensors 118 may be communicatively coupled to a controller 126 that controls one or more parameters associated with the performance of gas turbine engine 12. Controller 126 may be communicatively coupled to flow control devices 104, as discussed herein. Controller 126 may transmit one or more output signals used to adjust flow control devices 104 based on input signals received from one or more sensors 118. Controller 126 may also be communicatively coupled to flow measurement device 110. Controller 126 may use input signals received from flow measurement device 110 as a feedback output signal for input signals transmitted to flow control devices 104.

Sensors 118 may include any other sensors that enable diluent supply system 100 to function as described herein. For example, in some embodiments, sensors 118 may include an optical sensor that detects a flame intensity within combustor section 22. The optical sensor transmits a signal to controller 126 corresponding to an intensity of the flame. In some embodiments, sensors 118 include a sensor that interacts with exhaust gases 32 exiting turbine section 28. For example, sensors 118 may suitably be coupled to an exhaust duct (not shown) downstream from turbine section 28. Additionally, or alternatively, sensors 118 may be coupled to an exhaust stack (not shown) to obtain a measurement of temperature and/or composition of exhaust gases 32 exiting a selective catalytic reduction (SCR) treatment system (not shown). Sensors 118 may additionally, or alternatively, sense an amount of unburned hydrocarbons in exhaust gases 32. Sensors 118 may obtain any other measurement of exhaust gases 32 that enable power generation system 10 to function as described herein.

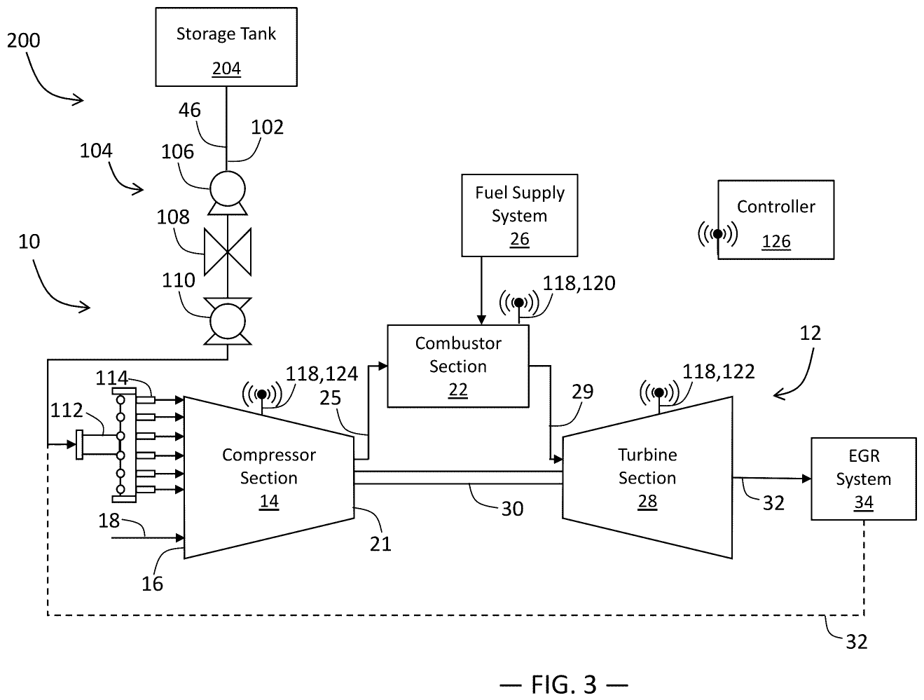

With reference to FIG. 3, another exemplary embodiment of power generation system 10 including a diluent supply system 200 is illustrated. Diluent supply system 200 includes a storage tank 204 that stores a volume of diluent 46. Storage tank 204 is coupled in fluid communication with compressor section 14, e.g., through one or more conduits 102 used to channel fluid from storage tank 204 to compressor section 14. Diluent supply system 200 includes flow control devices 104, e.g., pumps 106 and valves 108 and flow measurement device 110. Diluent supply system 200 also includes manifold 112 and/or one or more nozzles (not shown) for supplying diluent 46 to compressor section 14.

In some embodiments, storage tank 204 is in fluid communication with air separation unit 40 (FIG. 2), and diluents 46 are transferred from air separation unit 40 to storage tank 204 for storage. For example, diluent 46 may be directed from air separation unit 40 to storage tank 204 through conduits 102 using flow control devices 104 and/or gravity, wherein diluent 46 is stored until diluent 46 is subsequently supplied to compressor section 14, as needed based on the emission performance of gas turbine engine 12.

In the exemplary embodiments illustrated in FIGS. 2 and 3, diluent supply systems 100 and 200 supply diluent 46 to power generation system 10 without requiring compression from an auxiliary compressor, e.g., diluent compressor 36, used to compress diluent 46 separately from the compression of ambient air 18, as shown in power generation system 10 illustrated in FIG. 1. In other words, in the exemplary embodiments of FIGS. 2 and 3, there is not an additional and/or a separate compressor that requires its own power source and/or that draws power from gas turbine engine 12. Rather, diluent 46 is supplied directly to compressor section 14 where diluent 46 and ambient air 18 are compressed before the resulting mixture is directed to combustor section 22. Accordingly, embodiments described herein facilitate improved emission performance while improving the energy efficiency of power generation system 10. Alternatively, and/or additionally, diluent supply systems 100 and 200 may introduce exhaust gases 32 into compressor section 14, without compressing exhaust gases 32 using an auxiliary compressor, such as diluent compressor 36 (FIGS. 2 and 3). For example, exhaust gases 32 may be used to supplement, e.g., used in addition to, another diluent 46 supplied to the compressor section 14, e.g., from the air separation unit 40 and/or the storage tank 204. The exhaust gases 32 may be mixed with diluent 46, prior to being introduced into the compressor section 14 or the exhaust gases 32 and diluent 46 may be passed through manifold 112, together. In another example, exhaust gases 32 may be solely supplied as the diluent 46 to the compressor section 14.

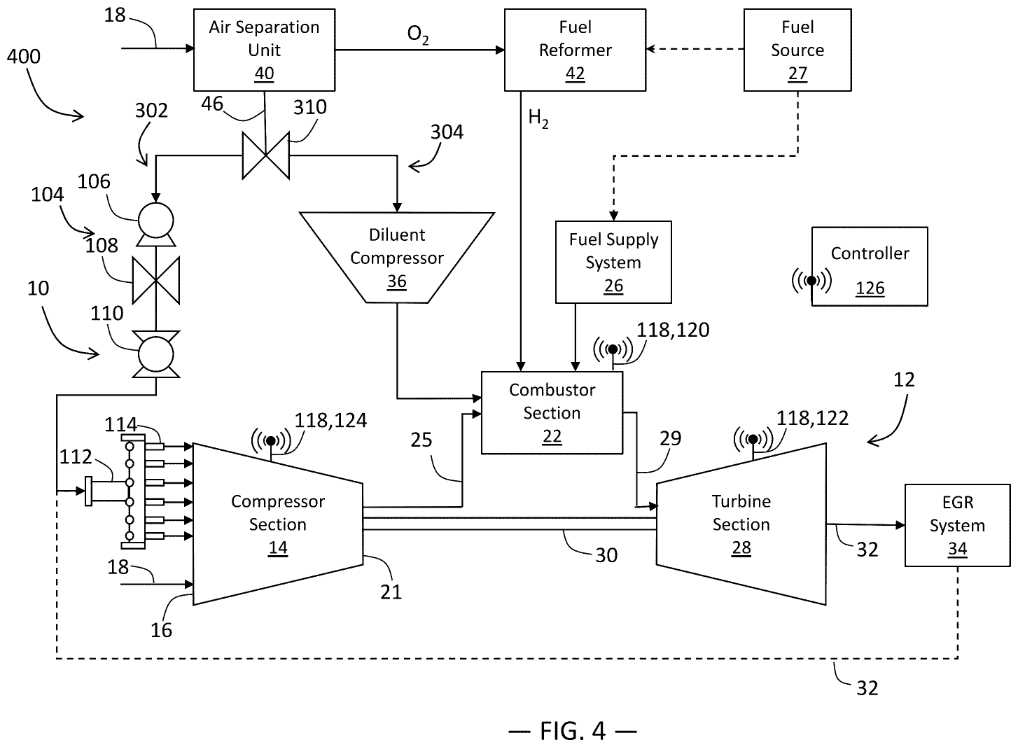

FIG. 4 illustrates another exemplary diluent supply system 300 for use with power generation system 10. Diluent supply system 300 includes a compressor diluent flow path 302 and a combustor diluent flow path 304. Compressor diluent flow path 302 supplies a first portion of diluent 46 to compressor section 14. Combustor diluent flow path 304 supplies a second portion of diluent 46 to combustor section 22, e.g., through diluent compressor 36. The relative ratio of the first and second portions may be selectively adjusted based on the operating needs and/or the emission performance of power generation system 10. In some embodiments, the first portion is a higher percentage of the total flow of diluent 46 compared to the second portion, such that a majority of diluent 46 is supplied directly to compressor section 14 and the remaining minority of diluent 46 is supplied to diluent compressor 36 before the compressed diluent 46 is supplied to combustor section 22. Because only a minority portion of diluent 46 is being compressed by diluent compressor 36, diluent compressor 36 can be sized accordingly, thereby reducing capital and operating expenses and reducing parasitic power losses from the gas turbine engine 12.

Diluent supply system 300 may include one or more control valves 310, e.g., a splitter valve and/or a two-way valve, used to control and/or adjust the relative amounts of the first and second portions of diluent 46 flowing respectively through compressor diluent flow path 302 and combustor diluent flow path 304. Control valve 310 is communicatively coupled to controller 126. Controller 126 may transmit one or more signals to control valve 310 based on one or more signals received from sensors 118. Diluent supply system 300 may include one or more flow measurement devices 110 that measure a flow parameter of either, or both, of the flow of diluent 46 through each of compressor and combustor diluent flow paths 302, 304. In some embodiments, compressor diluent flow path 302 and combustor diluent flow path 304 are independent, having separate paths, and each of diluent flow paths 302 and 304 have their own flow control devices 104 used to control a flow of diluent 46 therethrough. Alternatively, and/or additionally, diluent supply system 400 may introduce exhaust gases 32 into compressor section 14, without compressing exhaust gases 32 using an auxiliary compressor, such as diluent compressor 36 (FIG. 4). For example, exhaust gases 32 may be used to supplement, e.g., used in addition to, another diluent 46 supplied to the compressor section 14. The exhaust gases 32 may be mixed with diluent 46, prior to being introduced into the compressor section 14 or the exhaust gases 32 and diluent 46 may be passed through manifold 112, together. In another example, exhaust gases 32 may be solely supplied as the diluent 46 to the compressor section 14.

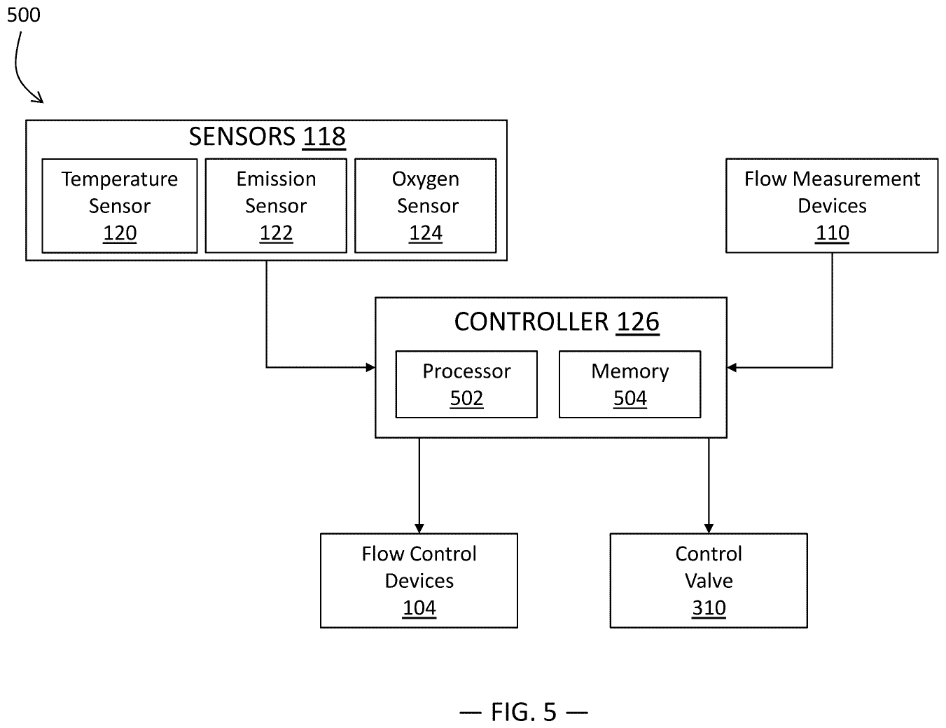

FIG. 5 shows an exemplary block diagram of a diluent control system 500 including controller 126. Diluent control system 500 controls a supply of diluent 46 to compressor section 14. For example, system 500 may determine a supply rate, a mass flow rate, and/or a volume of diluent 46 supplied to compressor section 14. In some embodiments, system 500 supplies diluent 46 at a constant supply rate, a constant mass flow rate, a constant ratio of diluent 46 to ambient air 18, and/or a constant ratio of diluent 46 to fuel, during at least a portion of a power generation operation. In some embodiments, system 500 may determine an appropriate supply of diluent 46 during a calibration period, prior to combustion, and then system 500 may maintain the determined amount of diluent 46, and/or a ratio, during at least a portion of the power generation operation. In alternative embodiments, system 500 may adjust the supply of diluent 46 during at least a portion of the power generation operation. For example, system 500 may adjust the supply of diluent 46 based on operational parameters and/or the production of pollutants, as detected by sensors 118.

Controller 126 includes a processor 502 that is communicatively coupled to a memory 504. Memory 504 may include a non-transitory computer-readable medium and program that are accessed by processor 502 to execute operations to control diluent 46 supplied to compressor section 14. Controller 126 is communicatively coupled to one or more sensors 118 and receives one or more input signals from sensors 118, which include measurements related to the emission performance of gas turbine engine 12.

As described in more detail above, one or more sensors 118 may include temperature sensor 120, emission sensor 122, oxygen sensor 124, and/or any suitable sensor used to measure a parameter related to the emission performance of gas turbine engine 12. Controller 126 processes, using processor 502, one or more input signals received from sensors 118 and determines one or more output signals necessary to adjust flow control devices 104 and/or control valve 310.

In some embodiments, diluent control system 500 selectively adjusts a flow parameter of diluent 46 supplied to compressor section 14 to facilitate controlling a percentage of available oxygen present in working fluid 18, thereby controlling combustion temperatures. For example, increasing a mass flow rate of diluent 46 supplied to compressor section 14 increases a ratio of diluent 46 to ambient air 18, thus decreasing the percent available oxygen present in working fluid 18.

In some embodiments, operations executed by controller 126 may include applying a control algorithm to adjust a flow parameter of diluent 46. For example, in one embodiment, controller 126 is communicatively coupled to flow control devices 104 and control valve 310. Controller 126 may transmit output signals to flow control devices 104 to facilitate adjusting a flow parameter of diluent 46 that is being channeled, e.g., through conduits 102, to compressor section 14. Likewise, controller 126 may transmit one or more output signals to control valve 310 to adjust the ratio of the first portion of diluent 46 to the second portion of diluent 46. Controller 126 may determine the ratio of the first and second portions based on, for example, signals received from sensors 118. Controller 126 may determine the ratio of the first and second portions before a power generation operation, e.g., during a calibration period, and then subsequently, controller 126 may maintain the ratio of the first and second portions of diluent 46 during at least a portion of the power generation process.

In some embodiments, controller 126 may include and/or generate an operational model of gas turbine engine 12. Controller 126 may compare a measurement of an emission performance parameter to the operational model to generate output signals to be transmitted to flow control devices 104 and/or control valve 310. The operational model may define operational and emission boundaries of gas turbine engine 12. In some embodiments, controller 126 may store, in memory 504, one or more threshold values associated with the emission performance of power generation system 10. Controller 126 may compare the input signals to one or more predefined threshold values. In instances when controller 126 determines that the input signals reach and/or pass the one or more threshold values, controller 126 may determine and transmit an output signal to flow control devices 104 and/or control valve 310.

In some embodiments, the output signals may be determined by controller 126 during a calibration period prior to a power generation operation of power generation system 10. The output signals, determined during calibration, may be used to set one or more flow parameters of diluent 46 supplied to compressor section 14 over a power generation operation. In other words, in some cases, the output signals controlling a flow parameter of diluent 46 may be held constant by controller 126 during the pendency of a power generation operation.

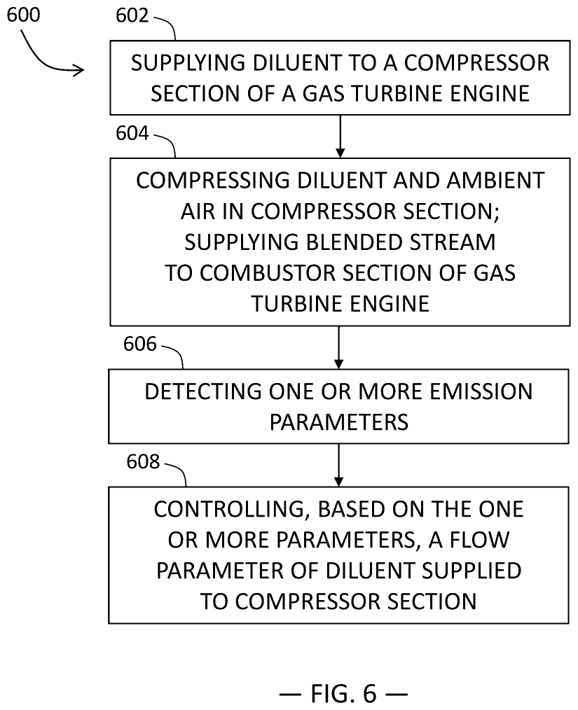

FIG. 6 is a flow chart of an exemplary method 600 for controlling diluent 46 supplied to a gas turbine engine, e.g., gas turbine engine 12, to improve emission performance. With reference to FIGS. 2-5, method 600 includes supplying 602 diluent 46 to compressor section 14 of gas turbine engine 12. In some embodiments, diluent 46 is supplied 602 to compressor section 14 from air separation unit 40. In some other embodiments, diluent 46 is supplied 602 to compressor section 14 from storage tank 204, which may or may not be coupled to air separation unit 40. Supplying 602 diluent 46 may include directing diluent 46 through conduits 102 using flow control devices 104 or any other suitable structures and devices to supply diluent 46 to compressor section 14. Supplying 602 diluent 46 may include distributing diluent 46 to compressor section 14 using manifold 112.

Method 600 includes compressing 604 diluent 46 and ambient air 18 together, via compressor section 14, and combusting the compressed mixture via combustor section 22. Method 600 may include detecting 606, using sensors 118, an emission parameter associated with gas turbine engine 12. Detecting 606 may include detecting an emission level using emission sensor 122, detecting combustion temperatures using temperature sensor 120, and/or detecting an oxygen level using oxygen sensor 124.

Method 600 includes controlling 608, by controller 126, a flow parameter of diluent 46. Controlling 608 may include determining one or more output signals to transmit to flow control devices 104 and/or control valve 310. In some embodiments, controlling 608 may include determining one or more output signals to transmit to flow control devices 104 and/or control valve 310 based on, at least in part, one or more input signals received from sensors 118. Controlling 608 by controller 126 a flow parameter of diluent 46 may include holding constant a flow parameter of diluent 46 over at least a portion of the combustion process.

In some embodiments, within the controlling step 608, method 600 may include determining a first portion of diluent 46 supplied to compressor diluent flow path 302 and a second portion of diluent 46 supplied to combustor diluent flow path 304, e.g., a ratio of the first portion to the second portion. Determining may include determining one or more output signals to transmit to control valve 310 based on one or more input signals received from sensors 118. Determining may include determining one or more output signals to transmit to control valve 310 to maintain the ratio of the first portion directed through compressor diluent flow path 302 to the second portion directed through combustor diluent flow path 304 over at least a portion of the power generation process.

The above-described systems and methods include supplying diluent to a compressor section of a gas turbine engine to improve emission performance. The supply of diluent and the emission performance may be controlled by adjusting a flow parameter of diluent in response to a detected emission behavior and/or power consumption of the gas turbine engine. Therefore, the systems and methods described herein facilitate optimizing emissions and power efficiency (megawatts) for the gas turbine engine. In at least some embodiments, the gas turbine engine does not require additional power consumption for an auxiliary compressor to compress the diluent, prior to supplying the compressed diluent to the combustor section. Rather, in embodiments described herein, diluent is supplied directly to the compressor section, such that the compressor section compresses the diluent and the ambient air together, prior to passing the compressed working fluid into the combustor section.

Exemplary technical effects of the systems and methods described herein include but are not limited to including: (a) facilitating improvements in overall power efficiency of the gas turbine engine by limiting the power consumption by eliminating the need for auxiliary compressors; and (b) facilitating improvements in emission performance of the gas turbine engine by supplying diluent to the working fluid compressed by the compressor section.

The methods and systems described herein are not limited to the specific embodiments described herein. For example, components of each system and/or steps of each method may be utilized independently and separately from other components and/or steps described herein. For example, the methods and systems may also be used in combination with other turbine systems and are not limited to practice only with the gas turbine engines as described herein. Rather, the exemplary embodiments can be implemented and utilized in connection with many other turbine applications.

Further aspects of the present disclosure are provided by the subject matter of the following clauses:
1. According to a first aspect, a method of supplying a diluent to a gas turbine engine is provided, the method comprising: injecting a diluent into a compressor section of the gas turbine engine; channeling ambient air into the compressor section; and compressing the diluent and ambient air together within the compressor section to facilitate improving emission performance of the gas turbine engine.
2. The method according to Clause 1, wherein supplying a diluent into the compressor section further comprises channeling the diluent from an air separation unit to the compressor section.
3. The method according to Clauses 1 or 2, wherein supplying a diluent into the compressor section further comprises channeling the diluent from the air separation unit to the compressor section without channeling the diluent through an auxiliary compressor.
4. The method according to any preceding clause, wherein supplying a diluent into the compressor section further comprises supplying nitrogen, N₂, as the diluent to the compressor section.
5. The method according to any preceding clause, wherein supplying a diluent into the compressor section further comprises supplying carbon dioxide, CO₂, as the diluent to the compressor section.
6. The method according to any preceding clause, wherein supplying a diluent into the compressor section further comprises distributing the diluent within the compressor section using a manifold.
7. The method according to any preceding clause, wherein the method further comprises: receiving, via a controller, a signal indicative of an emission behavior of the gas turbine engine; and controlling, via the controller, a flow of the diluent to the compressor section based on at least the signal.
8. The method according to Clause 7, wherein receiving a signal further comprises receiving a signal from at least one of an emissions sensor, a temperature sensor, and an oxygen sensor.
9. The method according to Clause 7, wherein controlling, based on at least the signal, comprises selectively adjusting a flow parameter of diluent supplied to the compressor section to facilitate improving emission performance of the gas turbine engine.
10. According to another aspect of the disclosure, a power generation system comprises: a gas turbine engine comprising: a compressor section comprising an inlet; a combustor section downstream from the compressor section; and a turbine section downstream from the combustor section, the turbine section discharging an exhaust gas therefrom during operation; and a diluent supply system for supplying a diluent to the compressor section, wherein the diluent and ambient air are compressed together by the compressor section before being routed downstream into the combustor section.
11. The power generation system of Clause 10, further comprising: an air separation unit for separating ambient air to produce the diluent, the air separation unit in fluid communication with the compressor section; and one or more flow control devices for use in controlling a flow parameter of the diluent channeled from the air separation unit to the compressor section.
12. The power generation system of Clauses 10 or 11, further comprising a manifold for distributing the diluent into the compressor section.
13. The power generation system of any of Clauses 10 to 12, further comprising: a storage tank for storing the diluent, wherein the storage tank is in fluid communication with the compressor section; and one or more flow control devices for selectively controlling a flow parameter of the diluent from the storage tank to the compressor section.
14. The power generation system of any of Clauses 10 to 13, wherein the diluent supply system supplies nitrogen, N₂, as the diluent to the compressor section.
15. The power generation system of any of Clauses 10 to 14, wherein the diluent supply system supplies carbon dioxide, CO₂, as the diluent to the compressor section.
16. The power generation system of any of Clauses 10 to 15, further comprising an exhaust gas reclaimer system downstream of the turbine section, wherein the exhaust gas reclaimer system is configured to recirculate a portion of the exhaust gas to the compressor as the diluent.
17. According to yet another aspect, a gas turbine engine comprising: a compressor section comprising an inlet; a combustor section downstream from the compressor section; a turbine section downstream from the combustor section, the turbine section discharging an exhaust gas therefrom during operation; and a diluent supply system for supplying a diluent into the compressor section, wherein the diluent and ambient air are compressed together by the compressor section before being routed downstream into the combustor section, the diluent supply system comprising at least one flow control device for controlling a flow parameter of the diluent supplied to the compressor section.
18. The gas turbine engine according to Clause 17, further comprising a controller communicatively coupled to an emission sensor and to the at least one flow control device, the controller configured to control a flow of nitrogen, N₂, as the diluent to the compressor section.
19. The gas turbine engine according to Clauses 17 or 18, wherein the diluent supply system comprises a manifold configured to distribute the diluent within the compressor section.
20. The gas turbine engine according to any of Clauses 17 to 19, wherein the diluent supply system further comprises at least one of an emissions sensor, a temperature sensor, and an oxygen sensor, the at least one of an emissions sensor, a temperature sensor, and an oxygen sensor being communicatively coupled to a controller the diluent supply system.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments of systems and methods, including the best mode, and also to enable any person skilled in the art to practice the systems and methods, including making and using any devices or systems and performing any incorporated methods. The patentable scope of the systems and methods is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of supplying a diluent to a gas turbine engine, the method comprising:
injecting a diluent into a compressor section of the gas turbine engine;
channeling ambient air into the compressor section; and
compressing the diluent and ambient air together within the compressor section to facilitate improving emission performance of the gas turbine engine.

2. The method according to claim 1, wherein supplying a diluent into the compressor section further comprises channeling the diluent from an air separation unit to the compressor section.

3. The method according to claim 2, wherein supplying a diluent into the compressor section further comprises channeling the diluent from the air separation unit to the compressor section without channeling the diluent through an auxiliary compressor.

4. The method according to claim 1, wherein supplying a diluent into the compressor section further comprises supplying nitrogen, N2, as the diluent to the compressor section.

5. The method according to claim 1, wherein supplying a diluent into the compressor section further comprises supplying carbon dioxide, CO2, as the diluent to the compressor section.

6. The method according to claim 1, wherein supplying a diluent into the compressor section further comprises distributing the diluent within the compressor section using a manifold.

7. The method according to claim 1, wherein the method further comprises:
receiving, via a controller, a signal indicative of an emission behavior of the gas turbine engine; and
controlling, via the controller, a flow of the diluent to the compressor section based on at least the signal.

8. The method according to claim 7, wherein receiving a signal further comprises receiving a signal from at least one of an emissions sensor, a temperature sensor, and an oxygen sensor.

9. The method according to claim 7, wherein controlling, based on at least the signal, comprises selectively adjusting a flow parameter of diluent supplied to the compressor section to facilitate improving emission performance of the gas turbine engine.

10. A power generation system comprising:
a gas turbine engine comprising:
a compressor section comprising an inlet;
a combustor section downstream from the compressor section; and
a turbine section downstream from the combustor section, the turbine section discharging an exhaust gas therefrom during operation; and
a diluent supply system for supplying a diluent to the compressor section, wherein the diluent and ambient air are compressed together by the compressor section before being routed downstream into the combustor section.

11. The power generation system of claim 10, further comprising:
an air separation unit for separating ambient air to produce the diluent, the air separation unit in fluid communication with the compressor section; and
one or more flow control devices for use in controlling a flow parameter of the diluent channeled from the air separation unit to the compressor section.

12. The power generation system of claim 10, further comprising a manifold for distributing the diluent into the compressor section.

13. The power generation system of claim 10, further comprising:
a storage tank for storing the diluent, wherein the storage tank is in fluid communication with the compressor section; and
one or more flow control devices for selectively controlling a flow parameter of the diluent from the storage tank to the compressor section.

14. The power generation system of claim 10, wherein the diluent supply system supplies nitrogen, N2, as the diluent to the compressor section.

15. The power generation system of claim 10, wherein the diluent supply system supplies carbon dioxide, CO2, as the diluent to the compressor section.

16. The power generation system of claim 10, further comprising an exhaust gas reclaimer system downstream of the turbine section, wherein the exhaust gas reclaimer system is configured to recirculate a portion of the exhaust gas to the compressor as the diluent.

17. A gas turbine engine comprising:
a compressor section comprising an inlet;
a combustor section downstream from the compressor section;
a turbine section downstream from the combustor section, the turbine section discharging an exhaust gas therefrom during operation; and
a diluent supply system for supplying a diluent into the compressor section, wherein the diluent and ambient air are compressed together by the compressor section before being routed downstream into the combustor section, the diluent supply system comprising at least one flow control device for controlling a flow parameter of the diluent supplied to the compressor section.

18. The gas turbine engine according to claim 17, further comprising a controller communicatively coupled to an emission sensor and to the at least one flow control device, the controller configured to control a flow of nitrogen, N2, as the diluent to the compressor section.

19. The gas turbine engine according to claim 17, wherein the diluent supply system further comprises a manifold configured to distribute the diluent within the compressor section.

20. The gas turbine engine according to claim 17, wherein the diluent supply system further comprises at least one of an emissions sensor, a temperature sensor, and an oxygen sensor, the at least one of the emissions sensor, the temperature sensor, and the oxygen sensor being communicatively coupled to a controller of the diluent supply system.
